(19) United States
(12) Patent Application Publication
(10) Pub. No.: US 2018/0050735 A1
(43) Pub. Date: Feb. 22, 2018

(54) COMPOSITE FLOOR, VEHICLE COMPRISING SUCH A FLOOR, METHOD FOR THE PRODUCTION OF THE FLOOR AND METHOD FOR THE PRODUCTION OF THE VEHICLE

(71) Applicant: AUTOMOTIVE EXTERIORS EUROPE, Lyon (FR)

(72) Inventors: Philippe JAUNASSE, Paris (FR); Cyrille GUYON, Nommay (FR)

(21) Appl. No.: 15/512,803

(22) PCT Filed: Sep. 18, 2015
(86) PCT No.: PCT/EP2015/071503

§ 371 Date: Nov. 4, 2017

(30) Foreign Application Priority Data
Sep. 18, 2014 (FR) 14 58842

(51) Int. Cl. B62D 29/00; B62D 25/20; B60R 13/08; B62D 65/02

(52) U.S. Cl. CPC B62D 29/004; B62D 65/02; B60R 13/083; B62D 25/20

(57) ABSTRACT

A vehicle floor includes: an upper floor made from a composite material; and a lower floor made from a composite material. The floor includes between the upper floor and the lower floor a sound-absorbing layer and an air knife.

The invention relates in general to the floors of vehicles.

More precisely, according to a first aspect the invention relates to a vehicle floor, of the type that comprises:
an upper floor made from a composite material in one or more parts;
a lower floor made from a composite material in one or more parts, facing at least one part of the upper floor, the lower and upper floors being bonded to one another along at least one line of attachment and delimiting between them at least one hollow section.

Floors of such type are known for example from the document FR 2 912 108. Such floors are light, but are not entirely satisfactory from the point of view of sound-proofing or sound-absorbing.

In this context, the invention aims to provide a floor that presents improved sound-proofing performance.

To this end, the invention relates to a floor of the aforementioned type, characterized in that the floor includes between the upper floor and the lower floor, within the interior of the hollow section, at least one layer of sound-insulating material and an air layer superposed on to the sound-absorbing layer.

The integration of a sound-absorbing layer and an air layer between the upper and lower floors makes it possible to enhance in a very significant manner the sound-proofing provided by the floor, and this is brought about without increasing the space requirement in the vehicle cabin. Indeed, for reasons related to rigidity, the lower and upper floors are not positioned to be pressed against each other, but on the contrary, are placed at a distance away from each other so as to delimit between them one or more hollow section(s). These hollow sections improve the rigidity of the floor. It is beneficial to take advantage of the space available within the hollow section in order to accommodate the sound-absorbing layer and the air layer.

For the transmission of the noises and vibrations, the floor displays behavior akin to double glazing. Its sound-proofing performance aspects are thus very good.

The use of a composite structure thus presents, in particular as compared to a conventional floor made of steel, a decrease in the mass per unit area or basis weight (unfavorable to the acoustic performance in mass law) and an increase in the stiffness of the sub-assembly (which results in an increase in the radiation factor of the floor that is particularly critical at high frequencies).

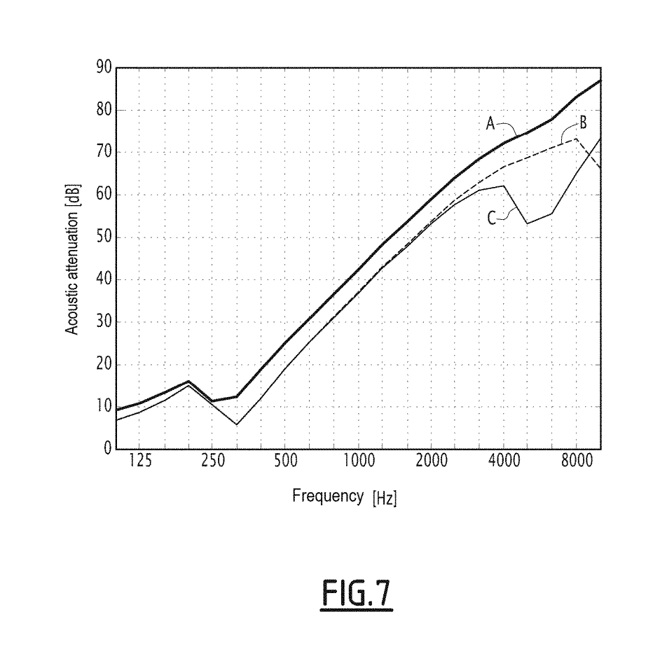

These phenomena are illustrated in FIG. 7 which represents the sound attenuation as a function of the frequency. The curve A, which offers the best performance, represents a conventional floor made of steel, covered with a sound-proofing layer and a floor mat or carpet. It is found to be degraded into a curve B when the weight of the floor is decreased by 40% and a curve C if in addition the stiffness of the floor is increased by 40%, which corresponds to a composite floor.

In order to compensate for these two phenomena and to attain the level of acoustic performance provided by conventional floors made of steel, a known solution would consist of placing upon such a type of composite floor a mat/sound-absorbing material assembly having a significant weight, such that overall the composite floor solution with the mat/sound-absorbing material would lead to a weight that is close to or even higher than that of the conventional floor solution.

On the contrary, the solution proposed in the invention instead makes it possible to achieve good acoustic performance by effectively making use of low weight sound-absorbing materials. Indeed, the sound-absorbing layer and air layer integrated between the two composite floors make it possible to mechanically decouple the upper and lower floors in order to minimize the solid- or structure-borne transfers through the floor as well as the radiation, both at medium as also high frequencies. The addition of a low weight mat/sound-absorbing material assembly over the upper floor comprehensively enhances the sound insulation and thus makes it possible to achieve performance levels that are superior to the known solutions which make use of a steel floor. The total weight of the assembly nevertheless continues to remain well below the weight of the conventional solution.

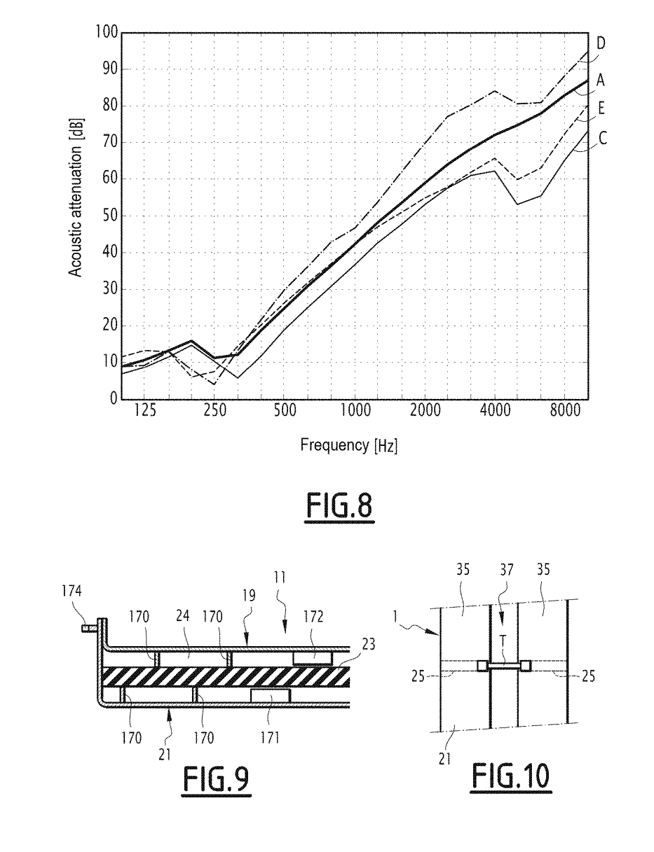

FIG. 8 illustrates the beneficial value of this solution. The performance data of a composite floor with sound-absorbing layer and air layer between the lower floor and upper floor, plus a sound-absorbing floor mat over the upper floor, are represented by the curve D, which may be compared to the curve A (conventional solution with floor made of steel and sound-absorbing floor mat), to the curve C (structure which is identical to that of curve A, with a composite floor in place of the steel floor), and to the curve E (structure which is identical to that of the curve C, with a thicker sound-absorbing layer).

The upper floor is typically positioned so as to face the interior of the passenger compartment of the vehicle. On the contrary, the lower floor is normally positioned so as to face the surface of the vehicle.

The composite material forming the upper floor comprises of long fibers, such as for example glass fibers and/or fibers of carbon and/or aramid fibers and/or plant fibers. By way of a variant, it comprises of short fibers. The fibers are arranged in the form of woven textiles, non-woven unidirectional textiles, or even cut long fibers based non-woven textiles.

These fibers are embedded in a thermoplastic resin, which is suitable for being formed by means of thermo-stamping with short cycle times, of the order of one minute. The thermo-stamping is a method of hot stamping. The resin is for example a polyamide- or polypropylene based resin. By way of a variant that is not preferred, the fibers are embedded in a thermo-durable resin or vitremer resin, for example a polyester or epoxy based resin, etc.

The upper floor typically has a thickness comprised between 1 mm and 6 mm.

The composite material of the lower floor is, for example, identical to the composite material of the upper floor. By way of a variant, it is different. It also comprises of long fibers, such as for example glass fibers and/or fibers of carbon and/or aramid fibers and/or plant fibers. By way of a variant, it comprises of short fibers. The fibers are arranged in the form of woven textiles, non-woven unidirectional textiles, or even cut long fibers based non-woven textiles.

These fibers are embedded in a thermoplastic resin, which is suitable for being formed by means of thermo-stamping with short cycle times, of the order of one minute. The thermo-stamping is a method of hot stamping. The resin is for example a polyamide- or polypropylene based resin. By way of a variant that is not preferred, the fibers are embedded in a thermo-durable resin and/or vitremer resin, for example a polyester or epoxy based resin, etc.

The lower floor typically has a thickness comprised between 1 mm and 6 mm.

The lower floor is extended in front of the greatest portion of the upper floor. For example, it is extended in front of at least 50% of the surface of the upper floor.

By way of a variant, the lower and/or upper floors are not formed by means of thermo-stamping but by any other suitable method, depending on the nature of the materials and the form and shape to be obtained.

According to another variant, the floor comprises over-molded elements on the lower and/or upper floors, that make it possible to integrate additional functions on to the lower and/or upper floors. These elements are for example stiffening ribs, feed-through ducts/raceways for running cables, housings or enclosures intended to accommodate various equipment units (calculators, connectors, etc), clips meant for attachment of the floor on to the vehicle. These elements are made out of a material typically comprising a thermoplastic resin and short fibers embedded in the resin. The resin is preferably the same as the resin of which the lower and/or upper floors are formed.

The floor typically includes a single sound-absorbing layer inserted into the hollow sections formed by the said floors. By way of a variant, it includes multiple sound-absorbing layers, arranged one over the other.

The sound-absorbing layer is of any suitable type:
a foam (for example, polyurethane or polyester)
a felt made from cellulose fibers or from a fibrous material displaying better temperature resistance properties (polyester or polyamide).

The choice of a fibrous material or a foam should be made based on the objectives in respect of damping that the sound-absorbing assembly ought to be contributing to the composite solution.

If increased acoustic performance needs happen to be necessary, the integrated sound-proofing solution combines two layers of felt of different resistivities (commonly known as bipermeable), a layer of foam and a layer of felt, or even a spring layer (foam or felt) and a septum (heavy mass). The heavy mass is generally made from a thermoplastic containing polyolefins or EVA (Ethyl Vinyl Acetate) and mineral/inorganic fillers.

The sound-absorbing layer covers preferably at least 50% of the surface of the lower floor.

According to an advantageous variant, the sound-absorbing layer is a foam that has been cast or injected into the hollow sections formed between the upper and lower floors. This foam is injected through orifices formed in or between the upper and lower floors. The foam is typically cast or injected after the floor has passed through a process of cataphoresis, which is particularly advantageous. Indeed, when the sound-absorbing layer is placed in the hollow section prior to its passing through the cataphoresis process, these hollow sections must be completely sealed in order to ensure that the sound-absorbing layer is not damaged in the cataphoretic baths. This creates several difficulties:
the floor behaves like a buoy and is difficult to immerse completely in the baths;
it is possible that a swelling may be induced in the sealed hollow sections and lead to a deformation of the floor during the firing process, under the effect of the increase in temperature;
in the event of a leak, the cataphoresis fluid is trapped within the interior of the hollow section.

These difficulties are avoided if the sound-absorbing layer is a foam that has been cast or injected after the cataphoresis, since the hollow sections are not sealed during the cataphoresis process.

The air layer is a layer typically covering the entire sound-absorbing layer, that is to say, 100% of the surface of the sound-absorbing layer.

Generally, the sound-absorbing layer is arranged to be pressed flat against the lower floor, with the air layer being interposed between the sound-absorbing layer and the upper floor. By way of a variant, the sound-absorbing layer is arranged to be pressed flat against the upper floor, with the air layer being interposed between the sound-absorbing layer and the lower floor. In this configuration the sound-absorbing layer is bonded to the floor. According to another variant, the floor includes within the interior of the hollow section an air layer interposed between the sound-absorbing layer and the upper floor, and another air layer interposed between the sound-absorbing layer and the lower floor. The sound-absorbing layer is thus sandwiched between two air layers. This makes it possible to improve the sound insulation provided by the floor to an even greater degree. The sound-absorbing layer is held in place by relief members that are formed on the sound-absorbing layer and ensure the contact and spacing with the lower floor, and possibly also with the upper floor. Alternatively, studs or spacers are interposed between the sound-absorbing layer and the lower floor, and possibly also between the sound-absorbing layer and upper floor. According to another alternative, the relief members (for example, the ribs) are formed in the lower floor, and possibly also in the upper floor.

The term line of attachment is used herein to refer to a line along which the upper floor and the lower floor are attached to each other, directly or by means of additional complementary parts such as stiffening profiles or longitudinal side members of the chassis of the vehicle. The lower and upper floors are rigidly attached to each other along the line of attachment, in a continuous manner, for example by means of an adhesive bond, and/or in a discontinuous manner by means of a plurality of attachment members distributed along the line of attachment and/or by a continuous or discontinuous line of welding, for example a line of ultrasonic welding, or a line of laser welding.

The attachment members are, for example, self-piercing rivets, nails, or any other suitable type of attachment member.

These attachment lines surround each hollow section, and provide the floor with a high degree of rigidity.

According to one advantageous characteristic feature of the invention, the lower and upper floors are directly bonded to one another along at least one of the lines of attachment.

This makes it possible to rigidify or stiffen the floor, without the addition of heavy elements such as metal profiles.

All along the said lines of attachment, the lower and upper floors are in close proximity to one another, or are directly in contact and pressed against each other. This is achieved via adjustments made to the shape or form of the floors, for example by creating in the lower floor the relief members protruding out towards the upper floor, or conversely by creating in the upper floor the relief members protruding out towards the lower floor.

According to one advantageous characteristic feature of the invention, the floor includes at least one stiffening profile disposed in the hollow section.

The floor generally includes a plurality of stiffening profiles, distributed across different points of the floor.

According to one advantageous characteristic feature of the invention, the stiffening profile is made from a metal or a composite material. For example, it is made out of aluminum, or magnesium, or steel, or from any other suitable metal. When the profile is made from a composite material, it is typically pultrude. By way of a variant, the profiles are thermoformed with over-molding, molded, or fabricated by means of the Resin Transfer Moulding® or Sheet Moulding Compression (SMC) methods.

The profile presents a square section, or a rectangular section or a U-shaped section, or a section shaped like an omega, or any other suitable section.

According to one advantageous characteristic feature of the invention, the stiffening profiles extend mainly in the longitudinal or transversal directions, over the greatest part of a longitudinal length and/or of the cross-sectional width of the floor. This makes it possible in particular to transmit the longitudinal forces linked to the front impacts and the transverse forces linked to the side impact shocks and pole impact.

The terms referring to the longitudinal and transversal directions, the front, the rear, the right and the left are used herein in relation to the direction of normal motion of the vehicle.

According to one advantageous characteristic feature of the invention, the stiffening profile is rigidly attached to the upper floor and the lower floor. The stiffness or rigidity of the floor is thus increased. The stiffening profile is attached by means of an adhesive bond and/or by a line of welding and/or by attachment members such as those described here above.

According to another advantageous characteristic feature of the invention, the floor includes a layer of carpeting or a rug, covering the upper floor. The carpeting or the rug constitutes a supplementary sound-absorbing layer. It also improves the appearance of the floor.

According to another advantageous characteristic feature of the invention, the lower floor includes two lateral zones and one central zone that projects out towards the upper floor relative to the two lateral zones, with the central zone being interposed longitudinally between the two lateral zones and connecting the two lateral zones to each other, with the central zone delimiting a longitudinal tunnel.

This longitudinal tunnel is used to enable the passage of functional members of the vehicle, for example the exhaust line or even a transmission shaft for transmission of the engine torque to the rear wheels of the vehicle. It also allows for the transmission of force during impact.

In an example of the embodiment, the upper floor comprises two lateral parts, disposed on both sides of the central zone that protrudes out from the lower floor, and is not directly connected to each other.

According to another example of the embodiment, the upper floor presents a form that is similar to that of the lower floor, with two lateral portions and one central portion that projects outwards, connecting the two lateral portions to each other. The central portion that projects outwards covers in a cap-like manner the central zone that protrudes out from the lower floor. Typically, it is arranged such that at least over one part of its surface it is pressed against the central zone that protrudes out from the lower floor.

According to another advantageous characteristic feature of the invention, one or more of the attachment lines together define a closed contour, thus delimiting one or more closed hollow sections.

Such a box-shaped structure provides the ability to obtain an extremely high level of rigidity for the floor, superior to that of a floor made of stamped sheet steel. As a consequence, it is possible to reduce the rigidity of the rest of the metal structure of the vehicle, which decreases the total weight of the vehicle.

The floor typically includes yet other closed hollow sections, which are partially delimited by the lines of attachment and partially delimited by other structures of the vehicle: longitudinal side members, chassis cross members, etc.

According to another advantageous characteristic feature of the invention, the lines of attachment are effectively sealed against liquids, in particular against water, and various fluids.

This makes it possible to ensure that formation of water retention is prevented in the hollow section or sections, and thus reduces the risks of degradation of the sound-absorbing layer.

According to one advantageous variant of the embodiment, certain hollow sections are not completely closed, but on the contrary, are open at their two opposite longitudinal ends. These hollow sections thus define the passage ways for technical facilities that are installed in place by running them therethrough, such as cabling-wiring, circuits for braking, fuel, cooling, air conditioning, etc. These passage ways preferably extend across the entire length of the floor.

Typically, the sound-absorbing layer has a thickness comprised between 5 mm and 20 mm. Preferably this thickness is comprised between 7 mm and 15 mm.

Typically, the air layer has a thickness comprised between 5 mm and 50 mm. Preferably this thickness is comprised between 10 mm and 30 mm. It may be modularly adjusted based on the dimensions of the floor and the thickness of the sound-absorbing layer.

Such thickness values make it possible to obtain a very effective sound attenuation through the floor.

According to a second aspect, the invention relates to a vehicle that includes:
a chassis;
a floor having the characteristic features indicated here above, rigidly attached to the chassis.

Typically, the vehicle is a motor vehicle, for example a car, or a utility vehicle, or a truck.

The floor typically includes a front floor and a floor of the boot or luggage compartment.

The front floor typically extends between the front body panel of the vehicle and the transverse cross member referred to as “rear seat floor cross member”. The front body panel is a partition separating the engine compartment of the vehicle from the passenger compartment. The transverse cross member (rear seat floor cross member) is located at the boundary between a front floor, described herein, and the floor of the boot/luggage compartment that incorporates the 2nd row seats as well as the boot/luggage compartment of the vehicle. It connects the front floor to the floor of the boot/luggage compartment. The front floor is rigidly attached not only to the longitudinal side members of the vehicle, but also to the front body panel and to the transverse cross member referred to as “rear seat floor cross member”.

The longitudinal side members of the vehicle may be used to close certain hollow sections of the floor.

The front floor and the floor of the boot/luggage compartment preferably present the structure described here above. By way of a variant, only the front floor or only the floor of the boot/luggage compartment presents the structure described here above.

According to one advantageous aspect of the invention, the floor includes reinforcing members arranged in the hollow section, the vehicle includes seats that are directly attached to the reinforcing members.

This refers to the fact that the seats are not linked to the reinforcing members by means of the upper floor, or the lower floor. Instead, members such as tie-rods or screws or any other attachment members directly connect the seat to the reinforcing members through the upper floor.

In one example of embodiment, the seats are rigidly attached directly to a stiffening profile of the floor, of the type described here above. By way of a variant, the floor includes, between the upper floor and the lower floor, the reinforcing members that are specifically dedicated to the attachment of the seats of the vehicle. These reinforcing members are distinct from the stiffening profile or profiles. These members, for example, take the form of studs. More precisely, they are in the shape of bowls, of concavities turned so as to face the lower floor. The free edge of the bowl is extended towards the exterior of the bowl by way of a peripheral turned-out edge, pressed against the lower floor. The peripheral turned-out edge is rigidly attached on to the lower floor by one or more of the means indicated here above.

The reinforcing members may have other shapes: cylindrical, frustoconical shape, etc. The reinforcing members are metallic or made of a composite material.

According to a third aspect, the invention relates to a manufacturing method for manufacturing a floor having the characteristic features described here above, the method including the following steps:
procuring of at least two parts made out of thermoplastic composite material;
forming of the upper and lower floors by means of hot stamping of the two parts.

This makes it possible to obtain short cycle times, of the order of one minute for the stamping of the upper and lower floors. The cycle times for the thermosetting composites are by far much longer, of the order of several minutes. They depend on the time of polymerization of the resins.

The thermoplastic composite materials used are of the type described here above.

According to a fourth aspect, the invention relates to a manufacturing method for manufacturing a vehicle, the method including the following steps:
procuring of a floor having the characteristic features described here above;
gluing the floor on to a metal structure of the vehicle;
passing the metal structure and the floor through the cataphoresis process, with an anti-corrosion product being first deposited on the metal structure, and thereafter the metal structure and the floor being subjected to a firing operation, the glue being polymerized during the firing.

The floor and the metal structure form the body in white of the vehicle. The step of cataphoresis serves the purpose of depositing an anti-corrosion product over the metal parts of this body in white. It typically includes a sub-step during which the body in white passes through a cataphoresis bath, the anti-corrosion product being deposited with an electrostatic process on to the metal parts, followed by a sub-step of firing of the anti-corrosion product in a heat chamber. As a benefit, advantage is taken of the sub-step of firing integrated into the treatment by cataphoresis in order to polymerize or cure the adhesive bond.

According to an advantageous aspect of the invention, the method also includes the following steps:
over-molding at least one metallic pre-holding part on to the floor;
between the step of gluing and the firing operation, locking the floor in position in relation to the metal structure by making use of the or each pre-holding part, the or each pre-holding part being rigidly attached to the metal structure.

The assembly of a composite floor on the structure of the vehicle is particularly challenging, since it is necessary to attach a composite, typically a thermoplastic composite, to a metal structure.

The gluing provides for a very strong bond, but it is necessary to maintain the floor in position in relation to the metal structure of the vehicle at least until the polymerization of the adhesive bond.

The pre-holding part or parts make possible such locking in position thereof. The step of over-molding makes it possible to fasten the pre-holding part or parts on to the floor. Over-molding is a process that is well suited to the fastening of a metal part on a composite floor. The pre-holding part is embedded in a composite structure of the same nature as the floor. It is then attached to the metal structure by any relevant means appropriate for a metal on metal fastening: resistive spot welding, seam welding, rivet welding, bolt welding, etc.

After polymerization of the adhesive bond, the pre-holding part or parts contribute to the attachment of the floor on to the metal structure, in addition to the adhesive bond.

By way of a variant, the pre-holding part or parts are not over-molded on to the lower or upper floors, they are assembled by a suitable means (gluing, etc.).

By way of a variant, the pre-holding part or parts are not metal parts. These are clips made out of a thermoplastic material, over-molded on to the lower or upper floors. These clips cooperate with the complementary parts formed on the metal structure of the vehicle.

Other characteristic features and advantages of the invention will become apparent from the description that is given here below, purely by way of an indication and without any limitation, with reference being made to the attached figures, among which:

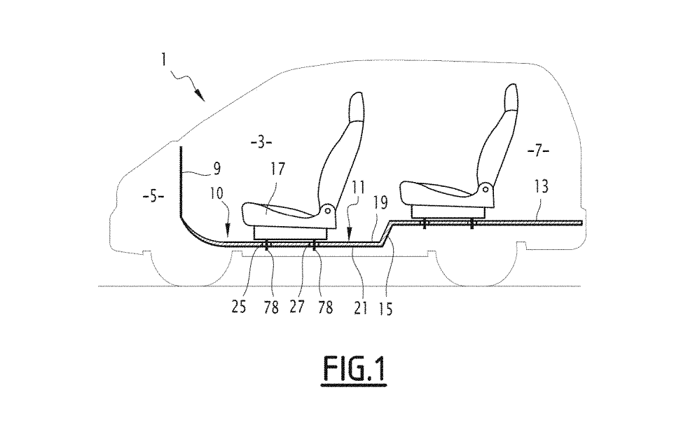

FIG. 1 is a simplified schematic representation of a motor vehicle that comprises a floor according to the invention;

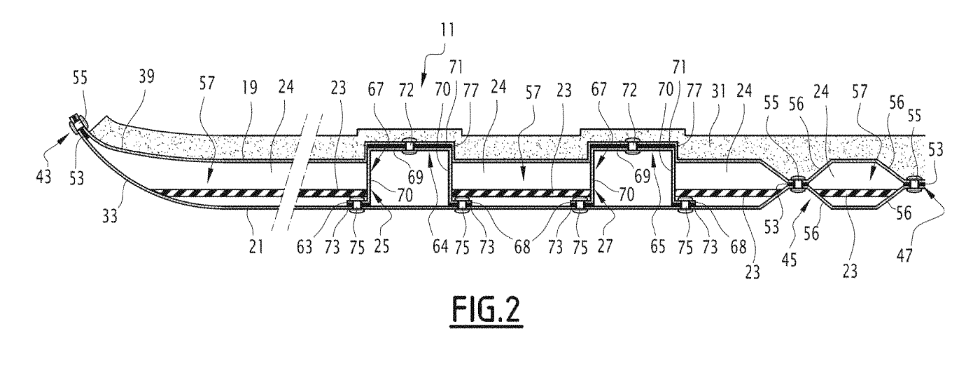

FIG. 2 is a longitudinal cross-section of the floor shown in FIG. 1;

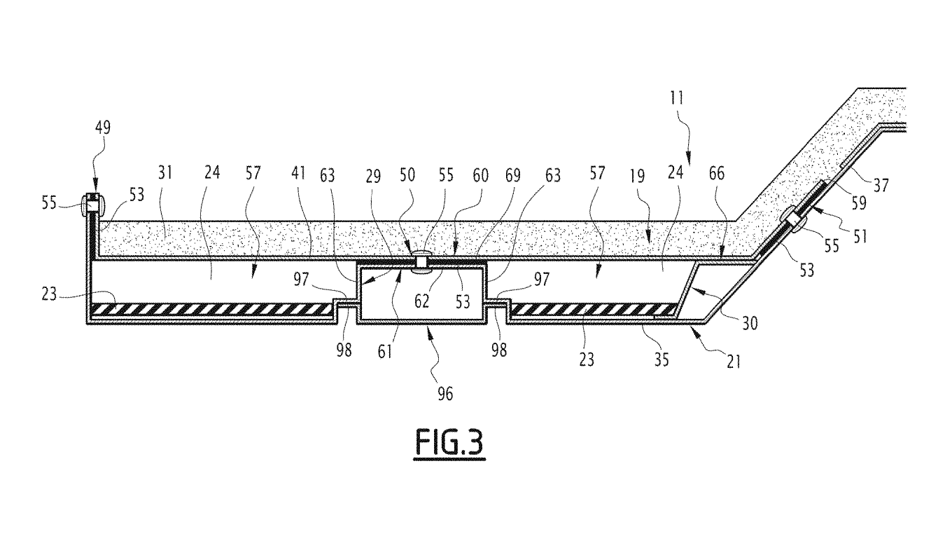

FIG. 3 is a transverse cross-section of one half of the floor shown in FIG. 2.

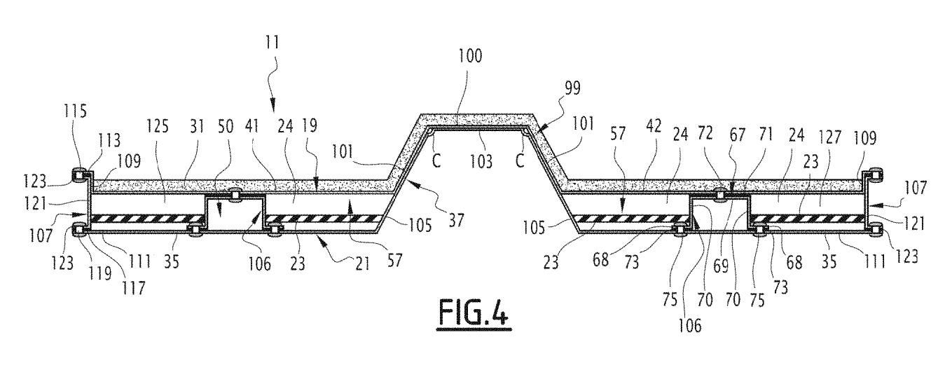

FIG. 4 is a transverse cross-section of a floor that incorporates variants of the embodiment of the invention;

FIG. 5 is a cross-sectional view of the attachment of the floor shown in FIG. 2 on a longitudinal side member of the vehicle; this longitudinal side member element is denoted by the term “sill liner”;

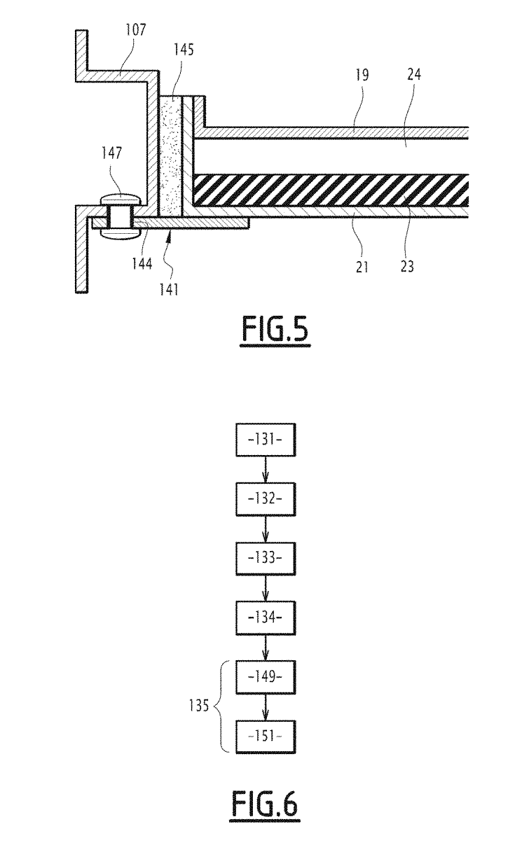

FIG. 6 is a step diagram illustrating the manufacturing method of the invention;

FIG. 7 represents the sound attenuation as a function of the frequency, for various different floors disclosed in the state of the art;

FIG. 8 is a graphic representation that is similar to that shown in FIG. 7, for various different floors disclosed in the state of the art and for a floor according to the invention; and

FIGS. 9 and 10 illustrate the variants of the embodiment of the invention.

The vehicle 1 represented in FIG. 1 includes a body that delimits in the vehicle a passenger compartment 3, an engine compartment 5 located in front of the passenger compartment, and a boot/luggage compartment 7 located in the rear of the passenger compartment. The engine compartment 5 is separated from the passenger compartment by a front body panel 9. The passenger compartment is delimited in the downward direction by a floor 10.

The front portion of the passenger compartment is the front zone of occupancy by passengers of a motor vehicle. It is delimited in the front by the front body panel 9 and at the rear by a transverse wall referred to as “rear seat floor cross member” 15.

Finally, this front portion is delimited in the downward direction by a zone of the floor 10 known as the front floor 11.

The rear portion of the passenger compartment extends from the base of the rear seat floor cross member (link between the front floor 11 and the rear seat floor cross member 15) at the front up to the rear cross-member of the vehicle (cross-member not represented). This rear portion incorporates the seats of the occupants of row 2 and the boot/luggage compartment. By way of a variant, it incorporates the seats of row 3.

The rear portion is delimited in the downward direction by a zone of the floor 10 known as the floor of boot/luggage compartment 13, which is slightly elevated relative to the front floor 11. The front floor 11 and the floor of the boot/luggage compartment 13 are connected to each other at the junction between the rear seat floor cross member 15 and the front floor 11.

The vehicle even includes seats 17, that are rigidly attached to the front floor 11 by means that will be described later.

In FIG. 1, a seat of the first row is represented as well as a seat of the second row.

The front floor 11 of the vehicle extends from the front body panel 9 up to the base of the rear seat floor cross member 15 along a longitudinal direction, and extends transversely substantially across the entire width of the vehicle. It is rigidly attached towards the front to the front body panel 9 and/or to any other structural cross-piece present in the zone, towards the rear of the rear seat floor cross member 15 and laterally on the chassis (not represented) of the vehicle, and more precisely on the longitudinal side members. This longitudinal side member element is denoted by the term “sill liner”.

The structure of the front floor 11 will now be described. The floor of the boot/luggage compartment 13 has the same structure in the example considered, and thus will not be described in detail.

As visible in FIGS. 2 and 3, the floor 11 includes:
an upper floor 19 made from a composite material;
a lower floor 21 made from a composite material, facing at least one part of the upper floor;
a sound-absorbing layer 23 that is interposed between the upper and lower floors 19 and 21;
an air layer 24, that is superposed on the sound-absorbing layer 23.

In the example shown, the floor 11 additionally also includes:
a plurality of stiffening profiles 25, 27, 29, 30 that are interposed between the upper and lower floors 19, 21; and
a layer of carpeting (sound-proofing mat) 31, preferably covering the upper floor 19.

The lower floor 21 is positioned so as to face the running surface of the vehicle. It defines an external surface of the vehicle, exposed to the atmosphere. Towards the front of the vehicle, it has an edge 33 that is slightly curved, which rises longitudinally from the rear to the front and is rigidly attached to the front body panel 9 of the vehicle (or to any structural cross-piece present in the zone). As is visible in FIGS. 4 and 5, the lower floor 21 has two lateral zones 35, located to the left and to the right of the floor, and one central zone 37 that protrudes out towards the upper floor relative to the two lateral zones 35. The lateral zones 35 and the central zone 37 extend substantially over the entire longitudinal length of the floor. The central zone 37 connects the two lateral zones 35 to one another, and this occurs over the entire length of the floor. As is visible in FIG. 4, the central zone 37 delimits a tunnel, that is open across from the upper floor 19, provided in order to enable the through-passage of the mechanical members of the vehicle and playing the role of reinforcement in frontal impact.

The upper floor 19 extends longitudinally over substantially the same length as the lower floor. It also features towards the front a raised edge 39, that is pressed against the raised edge of the lower floor (FIG. 2) 33.

As is visible in FIG. 4, the upper floor has two lateral portions 41 and 42 arranged on either side of the central zone 37 of the lower floor, and separated from each other by this central zone.

The upper and lower floors 19 and 21 are attached to one another along a plurality of lines of attachment.

Along the lines of attachment 43, 45, 47, 49, 50 and 51, the upper and lower floors 19, 21 are attached directly to each other. Along the said lines of attachment, the upper and lower floors 19 and 21 are arranged to be pressed against each other, with possibly interposing of a layer of bonding 53. The upper and lower floors 19 and 21 are arranged to be pressed against each other over the entire length or part thereof of the said lines. They are preferably rigidly attached to each other, in addition to the possible layer of bonding 53, by means of a plurality of attachment members 55, self-piercing rivets in the example shown, and/or by a continuous or discontinuous line of welding. These attachment members are regularly and evenly distributed along the lines of attachment 43, 45, 47, 49, 50 and 51. Only six lines of attachment are represented in the figures, but by way of a variant the floor has other attachment lines that are not represented.

As is visible in FIG. 2, the line of attachment 43 attaches the front edges 33 and 39, respectively, of the lower floor and the upper floor to each other. The lines of attachment 45 and 47 each attach a relief member 56 arranged in the upper floor to another relief member 56 arranged in the lower floor. The relief members 56 are depressions of transverse orientation, that are convex to each other. As is visible in FIG. 3, the line of attachment 49 attaches the left lateral edges of the upper and lower floors to one another. The right lateral edges of both floors are attached in the same way. The line of attachment 51 attaches a central edge 59 of the portion 41 of the upper floor 19 to the central zone of the lower floor 37. The central edge 59 extends longitudinally and delimits the portion 41 of the upper floor towards the center of the vehicle, that is to say, on the side of the central zone 37. The portion 42 is attached in the same way to the central zone 37.

The line of attachment 50 attaches an intermediate band 60 of the upper floor 19 to a relief member 61 provided in the lower floor 21. The relief member 61 protrudes out towards the upper floor 19. The intermediate band 60 and the relief member 61 extend longitudinally over the greatest portion of the length of the floor. The relief member 61 has a U-shaped transverse cross section, with a central portion 62 attached to the upper floor 19, and two lateral flanges 63 that are connected to the rest of the lower floor 21.

Moreover, the upper and lower floors 19 and 21 are attached to one another by means of additional complementary parts along the lines of attachment 64, 65, 66.

Along the lines of attachment 64 and 65, the upper and lower floors 19 and 21 are attached to each other by means of the profiles 25 and 27. These profiles are of transverse orientation.

In the example shown in FIGS. 2 to 4, each transverse profile 25, 27 has two sections, located on either side of the central zone 37. One of the sections is interposed between the portion 41 of the upper floor and the lower floor, and the other section between the portion 42 and the lower floor 21. The two sections are disjointed. They are located such that each is an extension of the other along the transverse direction.

According to a variant of the embodiment shown in FIG. 10, at least one tie-rod T is rigidly attached under the floor. It extends transversely, between and within the extension of the profiles 25 or 27. It is rigidly attached by its transverse ends to two zones 35 of the lower floor, its central portion extending above the central zone 37. Each tie-rod T serves the function of absorbing the lateral forces in the event of a lateral impact or pole impact shock, and of transferring the forces to the side opposite to the impact.

As is visible in FIG. 2, each of the profiles 25, 27 has, in transverse cross-section, a rectangular central core 67 and two bent-back edges with two flanges 68. The central core 67 is open towards the lower floor 21. It comprises a bottom 69 arranged to be pressed against the upper floor 19, and two lateral walls 70 opposite each other, that are integrally attached to the bottom 69 and substantially perpendicular to the latter. The bent-back edges 68 extend the lateral walls 70 towards the exterior of the profile, opposite the bottom 69. They are arranged to be pressed against the lower floor 21. The bottom 69 of the profile is rigidly attached to the upper floor 19, for example by a layer of glue 71 and/or by welding and/or a plurality of attachment members 72, which are rivets in the example represented.

The two bent-back edges with two flanges 68 are rigidly attached to the lower floor 21, by a layer of glue 73, and/or by welding and/or a plurality of attachment members 75, which are rivets in the example represented.

For example, as is visible in FIG. 2, a groove 77 is formed transversely in the upper floor 19 and delimits a concavity open towards the lower floor. It internally accommodates the profile 25, 27. It presents a form that is substantially complementary to the shape of the profile. This groove 77 advantageously forms a cross-piece, on which are attached the anchorages of the seats of the vehicle. Preferably, this cross-piece is provided in order to absorb the forces generated by a lateral impact to the vehicle. Typically, the groove 77 receives the bottom 69 of the profile, and a part of the lateral walls 70.

Along the line of attachment 66 (FIG. 3), the upper and lower floors 19 and 21 are attached to each other by means of the profile 30, visible in FIG. 3. This profile is of longitudinal orientation.

The floor for example comprises two profiles 30, disposed on either side of the central zone 37.

The profile 30 has a transverse cross section that is substantially S-shaped, with an upper flange attached to the upper floor 19, a lower flange attached to the lower floor, 21, and an inclined core connecting the upper and lower flanges to each other.

The upper and lower flanges are attached to the upper and lower floors for example by means of a layer of glue and/or by welding and/or by a plurality of attachment members such as rivets, these various means are not represented.

The lines of attachment 43, 45, 47, 49, 50, 51, 64, 65, 66 altogether define one or more closed contours. These closed contours thus delimit the closed hollow sections 57, provided between the upper floor and the lower floor. The presence of the closed hollow sections 57, and the attachment lines, provides a high degree of rigidity to the floor.

The seats 17 of the first row of seats in the vehicles are attached to the profiles 25 and 27 by means of tie-rods 78 represented schematically in FIG. 1. The tie-rods 78 pass through the floor mat 31 and the upper floor 19, and are engaged with the profiles 25 and 27.

According to a variant of the embodiment, the floor includes in addition at least one stiffening profile 96, placed outside the hollow sections 57. In the example shown in FIG. 3, the floor comprises two longitudinal profiles 96, located on either side of the central zone 37.

Each profile 96 is attached under the lower floor 21, to the right of the relief member 61. As is visible in FIG. 3, the lateral flanges 63 of the relief member 61 each have a longitudinal shoulder 97. The profile 96 has a form that is Ω shaped, its two bent-back edges 98 being rigidly attached to the two shoulders 97. The profile 96 is concave towards the relief member of 61. The relief member 61 and the profile 96 together form a hollow beam with closed section, which is particularly rigid.

According to one variant of the embodiment represented on FIG. 4, the upper floor 19 includes, in addition to the two lateral portions 41 and 42, a central portion 99, connecting the lateral portions 41 and 42 to each other. The central portion 99 protruding out opposite the lower floor 21 in relation to the lateral portions 41 and 42. It thus forms a boss having a longitudinally elongated form, that extends over virtually the entire length of the floor 1. The central portion 99 covers in a cap-like manner the central zone 37, and is supported against this central zone.

More precisely, the central portion presents a flattened top 100 and two flanks 101, connecting the flattened top 100 to the lateral portions 41 and 42. The central zone 37 of the lower floor has a similar form, also with a flattened top 103 and two flanks 105 connecting the flattened top 103 to the lateral zones 35. The flattened top 100 is supported against the top 103. It is attached to the latter by means of a layer of glue and/or by welding, for example by ultrasonic or laser welding and/or by mechanical attachment members such as rivets.

The flanks 101 are parallel to the flanks 105 and are supported against the latter. Each flank 101 is attached to the corresponding flank 105 by means of a layer of glue and/or by welding, for example by ultrasonic or laser welding and/or by mechanical attachment members such as rivets.

The layer of carpeting (the sound-proofing mat) 31 covers the central portion 99.

In the example of the embodiment illustrated in FIG. 4, the central zone 37 of the lower floor has two recessed zones C, that preferably extend longitudinally over the entire length of the floor. These recessed zones C are concave toward the upper floor 19. They are located for example at the level of the junctions between the flattened top 103 and the flanks 105. They each define with the upper floor a closed hollow section, increasing the rigidity of the floor in the upper part of the tunnel.

According to one variant of the embodiment represented in FIG. 4, the relief member 61 and the profile 96 are replaced by a longitudinal profile 106. The longitudinal profile 106 presents substantially the same form as the profiles 25 and 27. It is placed between the lower floor 21 and the upper floor 19. It is attached to the lower floor 21 and to the upper floor 19 like the profiles 25 and 27.

Furthermore, the sill liners 107 of the chassis of the vehicle linings are represented in FIGS. 4 and 5. These sill liners 107 extend longitudinally, one on the right and the other on the left of the vehicle. They are part of the chassis of the vehicle.

According to one variant of the embodiment, the respective exterior edges 109 and 111 of the upper and lower floors are not attached to each other, but instead are rigidly attached to the sill liners 107.

More precisely, as shown in FIG. 4, the upper floor 19 is delimited laterally by two edges 109, one situated on the left and the other on the right of the floor. The lateral edges 109 extend longitudinally substantially over the entire length of the floor. In a similar fashion, the lower floor 21 is delimited laterally by two lateral edges 111, one situated on the left and the other on the right of the vehicle. The lateral edges 111 extend over the entire longitudinal length of the floor.

Each of the two edges 109 of the upper floor 19 is rigidly attached on to a sill liner 107, for example by means of a layer of bonding 113 and/or by mechanical attachment members 115 such as rivets. In a similar fashion, each of the two lateral edges 111 is attached to one of the sill liners 107 by means of a layer of bonding 117 and by mechanical attachment members 119 such as rivets.

In the example represented, the sill liner has a C-shaped profile, with a central core 121, which presents two bent-back edges 123. The lateral edges 109 and 111 of the upper and lower floors 19 and 21 are each directly attached to one bent-back edge 123. The core 121 has a substantially vertical orientation, that is to say, substantially perpendicular to the running plane of the vehicle.

In this example of embodiment, there thus exists at least one closed hollow section 125 to the left of the central zone 37, and one closed hollow section 127 to the right of the central zone 37, which are each partially delimited by a sill liner 107. More precisely, the hollow sections 125 and 127 are delimited in the upward direction by the upper floor 19 in the downward direction by the lower floor 21, towards the interior of the vehicle by the longitudinal side member 106 and toward the exterior of the vehicle by the sill liners 107.

The sound-absorbing layer 23 extends across all the hollow sections 57, 125, 127. Preferably, it covers the entire surface of the lower floor 21, with the exception of the zones occupied by the stiffening profiles 25, 27, 29, 30, 106, and the central zone 37. By way of a variant, a sound-absorbing strip is placed within the interior of each profile.

The sound-absorbing material is a foam or a felt made of cellulose fibers, polyester fibers, or polyamide fibers.

The air layer 24 is a layer that covers the entire sound-absorbing layer 23, that is to say, 100% of the surface of the sound-absorbing layer. The profiles 25, 27, 29, 30, 106 are also filled with air.

The sound-absorbing layer 23 presents at any point a thickness comprised between 5 mm and 20 mm. Preferably this thickness is comprised between 7 mm and 15 mm.

The air layer 24 presents at any point a thickness comprised between 5 mm and 50 mm. Preferably this thickness is comprised between 10 mm and 30 mm.

In the variant embodiment illustrated in FIG. 9, the floor 10 includes elements that is over-molded on to the lower floors 21 and/or the upper floors 19. These elements are, for example, stiffening ribs, 170, feed-through ducts/raceways for running cables 171 housings or enclosures 172 intended to accommodate various equipment units (calculators, connectors, etc.), or even clips 174 meant for attachment of the floor on to the vehicle. These elements are made out of a material typically comprising a thermoplastic resin and short fibers embedded in the resin. The resin is preferably the same as the resin of which the lower and/or upper floors are formed.

The manufacturing method for manufacturing the floor 11 or 13 preferably includes the following steps:
procuring of at least two parts made out of thermoplastic composite material;
forming of the upper and lower floors 19, 21 by means of hot stamping of the two parts.

The hot stamping process is known per se. It will thus not be described in detail here. Each part is made out one of the thermoplastic materials described here above.

The hot stamping step makes it possible to give the upper 19 and lower 21 floors their virtually definitive shapes.

In addition, the method includes the following steps:
attachment of the stiffening profiles 25, 27, 30, 106 to the lower floor 21;
installation of the sound-absorbing layer 23 in place on the lower floor 21;
installation in place of the upper floor 19;
attachment of the upper floor 19 to the lower floor 21, along the lines of attachment 43, 45, 47, 49, 50 and 51;
attachment of the upper floor, 19 to the longitudinal profiles 25, 27, 30, 106;
by way of a variant, attachment of the profile 96 to the lower floor;
as may be appropriate, attachment of the upper and lower floors 19, 21 to the sill liners 107.

As may be appropriate, the method includes a step of over-molding of elements made out of thermoplastic material such as the elements 170, 171, 172, 174 on to the lower floor 21 and/or the upper floor 19.

The manufacturing method for manufacturing a vehicle incorporating the floor 11 will now be described with reference made to FIGS. 5 and 6.

The method includes:
a step 131, during the course of which a floor 10 is obtained that has the characteristic features described here above.
preferably an over-molding step 132 for over-molding at least one metallic pre-holding part 141 on to the floor;
a gluing step 133 for gluing of the floor 10 on to the metal structure of the vehicle;
preferably, an attachment step 134 for attaching the or each pre-holding part for holding the floor 10 in place on the metal structure.
a cataphoresis step 135 for passing the metal structure and the floor 10 through the cataphoresis treatment process.

The metal structure typically comprises the chassis of the vehicle. This chassis includes the sill liners 107. The chassis and the floor together constitute the body in white of the vehicle.

During the step 132, typically a plurality of pre-holding parts 141 are over-molded. The said parts 141 are typically pads of which a portion 144 protrudes out relative to the floor 10.

The over-molding step 132 makes it possible to integrally attach each pre-holding part 141 to the floor. Such an over-molding is well-known and will not be described in detail herein.

The gluing step 133 is carried out by depositing a layer of glue 145 on the floor 10 and/or on the metal structure, and by positioning the floor 10 to be pressed flat against the metal structure with interposing of the glue layer 145. This movement makes it possible to simultaneously position each pre-holding part 141 to be pressed up against the metal structure, as is visible in FIG. 5.

During the step 134 each pre-holding part 141 is attached by means of resistive spot welding, seam welding, rivet welding, such as the rivet 147 represented in FIG. 5, by bolt welding and/or by any other suitable method.

The cataphoresis step 135 for passing the components through the cataphoresis treatment process includes two sub-steps:
sub-step 149: depositing of an anti-corrosion product over the metal structure;
sub-step 151: subjecting the metal structure and the floor 10 to a firing operation.

As is known per se, the body in white passes through a cataphoresis bath during the sub-step 149, with the anti-corrosion product being deposited with an electrostatic process on to the metal parts. During the sub-step 151, the anti-corrosion product is subjected to a firing process in a heat chamber, with the adhesive bond being polymerized during the firing. The adhesive bond rigidly attaches the floor to the metal structure only once the polymerization has been brought about.

Between the bonding step 133 and the firing operation, the floor 10 is locked in position in relation to the metal structure by making use of the pre-holding parts 141.

1. A vehicle floor, the floor comprising:
an upper floor made from a composite material;
a lower floor made from a composite material, facing at least one part of the upper floor,
the lower and upper floors being bonded to one another along at least one line of attachment and delimiting between them at least one hollow section.
wherein the floor includes between the upper floor and the lower floor, within the interior of the or each hollow section, a sound-absorbing layer and an air layer superposed on to the sound-absorbing layer.

2. A floor according to claim 1, wherein the lower and upper floors are directly bonded to one another along at least one of the lines of attachment.

3. A floor according to claim 1, wherein the floor includes at least one stiffening profile disposed between the upper and lower floors.

4. A floor according to claim 3, wherein the stiffening profile is rigidly attached to the upper floor and/or to the lower floor.

5. A floor according to claim 1, wherein the lower floor includes two lateral zones and one central zone that projects out towards the upper floor relative to the two lateral zones, with the central zone being interposed transversely between the two lateral zones and connecting the two lateral zones to each other, with the central zone delimiting a longitudinal tunnel.

6. A floor according to claim 1, wherein one or more of the lines of attachment together define a closed contour, thus delimiting one or more closed hollow sections.

7. A floor according to claim 1, wherein the lines of attachment are effectively sealed against liquids.

8. A floor according to claim 1, wherein the sound-absorbing layer has a thickness comprised between 5 mm and 20 mm.

9. A floor according claim 1, wherein the air layer has a thickness comprised between 5 mm and 50 mm.

10. A vehicle that includes:
a chassis;
a floor according to claim 1, rigidly attached to the chassis.

11. A vehicle according to claim 10, wherein the floor includes reinforcing members arranged between the upper and lower floors, the vehicle having seats that are directly attached to the reinforcing members.

12. A manufacturing method for manufacturing a floor according to claim 1, the method including the following steps:
procuring of at least two parts made out of thermoplastic composite material;
forming of the upper and lower floors by means of hot stamping of the two parts.

13. A manufacturing method for manufacturing a vehicle, the method including the following steps:
procuring of a floor according to claim 1;
gluing the floor on to a metal structure of the vehicle;
passing the metal structure and the floor through the cataphoresis process, with an anti-corrosion product being first deposited on the metal structure, and thereafter the metal structure and the floor being subjected to a firing operation, the glue being polymerized during the firing.

14. A method according to claim 13, wherein the process also includes the following steps:
over-molding at least one metallic pre-holding part on to the floor;
between the step of gluing and the firing operation, locking the floor in position in relation to the metal structure by making use of the or each pre-holding part, the or each pre-holding part being rigidly attached to the metal structure.
